(19) United States
(12) Patent Application Publication
(10) Pub. No.: US 2008/0187141 A1
(43) Pub. Date: Aug. 7, 2008

(54) Method of transmitting vocal and musical signals via 2.4 GHz or higher wireless communication

(76) Inventor: Shu Wang, Rosemead, CA (US)

Correspondence Address: DAVID AND RAYMOND PATENT FIRM, 108 N. YNEZ AVE., SUITE 128, MONTEREY PARK, CA, 91754, US

(21) Appl. No.: 11/703,934

(22) Filed: Feb. 7, 2007

(51) Int. Cl. H04B 7/00

(52) U.S. Cl. 381/3

(57) ABSTRACT

A method of transmitting vocal/musical signal via 2.4 GHz or higher wireless communication includes the steps of collecting a vocal/musical signal from a microphone/musical instrument; modulating the vocal/musical signal via 2.4 GHz or higher band as radio frequency to form an uncompressed modulated signal; wirelessly transmitting the modulated signal through an audio streaming transceiver; demodulating the modulated signal into a digital signal; and converting the digital signal back to the vocal/musical signal in analog form to be outputted through the audio outputting device. The signal is uncompressed to keep CD-quality thereof and is transmitted in 2.4 GHz or higher band for preventing interference from other wireless equipments.

### BACKGROUND OF THE PRESENT INVENTION

1. Field of Invention

The present invention relates to the field of digital wireless communication and more particularly to the method of transmitting vocal/musical signals via 2.4 GHz or higher radio frequency with high audio quality, low interference, and effective performance.

2. Description of Related Arts

Wireless communication technique is rapidly developed in recent years. Wireless systems are portable, cordless and free from fixed location. Due to these inherent advantages, wireless systems are widely used from baby monitor to satellite communication.

Since the first wireless microphone went into production in early 1960's, wireless techniques have been utilized in vocal and audio transmitting. Now wireless systems have become increasingly popular as their sound quality, reliability and cost have improved. Generally a wireless system comprises three main components: an input device, a transmitter, and a receiver. The input device may be a microphone, or a music instrument like guitar. The transmitter converts the vocal or audio signal into a radio signal and broadcast through air. Then the receiver picks up the radio signal by its antenna, and converts the signal back to the vocal or audio signal for further performance.

There are two major concerns about the wireless system applied in vocal and audio transmitting: interference and sound quality. Radio signal is broadcasted at a unique radio frequency (RF) in the air. If other radio equipments emit radio signals at the same frequency, the transmitting will be distorted. Sound quality is a key factor to be considered in professional music field, it is critically determined by how much information can be carried by the radio frequency.

Currently, the wireless technique which are used in audio transmitting is generally analog technique, and the radio frequency is in the band of FM (88˜108 MHz), VHF (50 MHz and 200 MHz), and UHF (800 MHz). Since wireless equipments are getting more and more popular, all these frequency bands are crowded. The wireless equipments are much more possible to be interfered.

One solution has been used is the frequency hopping technique. Some wireless systems have multiple channels to communicate. A free channel can be pre-selected on both the transmitter and the receiver. But the problem is if interference happens when the system is working, no adjustment can be made. An alternative solution is automatically changing the frequency when interference happens. This passive frequency hopping technique still has some disadvantages. For example, when interference happens, it takes time to be detected. After that, both of the transmitter and the receiver should change the frequency and then be synchronized. This period of time will largely affect the real time transmitting.

### SUMMARY OF THE PRESENT INVENTION

To solve the problems of the radio frequency traffic, new frequency resource, as well as interference avoiding technique should be introduced. In 1985, the Federal Communications Commission (FCC) opened the 900 MHz, 2.4 GHz and 5.8 GHz bands for unlicensed use under FCC Part 15 rules. So working on the 2.4 GHz band (2400 to 2483.5 MHz) and 5.8 GHz bands (5725 to 5850 MHz) can avoid interference from most currently used wireless equipments. More over, new frequency hopping technique will be applied to further improve the capability of avoiding interference.

Another disadvantage of current wireless system in vocal and audio transmission is that analog technology can not support high fidelity. The frequency response of analog wireless products is limited because analog technique can not use the frequency resource efficiently. Working on 2.4 GHz and 5.8 GHz bands also provides a wider stream bandwidth, and a faster data transmission rate. Combined with the newly developed digital technology, it is possible to transmit high fidelity sound signals with the full frequency response of human hearing.

A main object of the present invention is to provide a method of transmitting vocal/musical signals via 2.4 GHz or higher wireless communication wherein the radio frequency can avoid interference in FM, VHF, and UHF frequency bands.

Another object of the present invention is to provide a method of transmitting vocal/musical signals via 2.4 GHz or higher wireless communication utilizing digital technology to transmit the full frequency band which can be felt by human ears without data loss compression and decoding, to realize high fidelity transmission, and to save the cost.

Another object of the present invention is to provide a method of transmitting vocal/musical signals via wireless communication using active dynamic frequency hopping technology to avoid being interfered by other wireless equipments, and also avoid interfering other wireless equipments.

Another object of the present invention is to provide a method of transmitting wireless signals via wireless communication using buffer transmitting to avoid error.

Another object of the present invention is to provide a wireless system, wherein vocal/musical signals are transmitted via 2.4 GHz or higher wireless communication with full frequency response of human hearing and strong anti-interference capacity.

Another object of the present invention is to provide a full duplex wireless system, wherein vocal and musical signals are transmitted and received in both directions at the same time, via 2.4 GHz or higher wireless communication with full frequency response of human hearing and strong anti-interference capacity.

Another object of the present invention is to provide a wireless microphone, wherein vocal/musical signals are transmitted via 2.4 GHz or higher wireless communication with full frequency response of human hearing, and strong anti-interference capacity.

Accordingly, in order to accomplish the above objects, the present invention provides a method of transmitting vocal and musical signals via 2.4 GHz or higher wireless communication, the method comprises steps of:

(a) inputting digital signals from microphone/musical instrument into one terminal of a wireless communication system; (b) modulating said digital signals via 2.4 GHz or higher band as radio frequency;

(c) broadcasting said modulated signals;

(d) receiving said broadcasted signals by another terminal of said wireless communication system;

(e) changing radio frequency actively;

(f) demodulating said received signals into digital signals; and

(g) outputting said digital signals.

The present invention also provides a method of transmitting signals via wireless communication with buffer transmitting, wherein the method comprises the steps of:

(a) collecting said wireless signal;

(b) wirelessly broadcasting said wireless signal via a wireless transmitter of said wireless communication system;

(c) receiving said wireless signal from a signal receiver of said wireless communication system;

(d) sending a requesting signal from said signal receiver to said signal transmitter when an error of said wireless signal is detected during wireless transmission; and

(e) re-broadcasting said wireless signal as a makeup signal via said wireless transmitter to replace said error of said wireless signal.

The present invention also provides a wireless system which comprises:

an input device which comprises an input terminal for connecting with a microphone/musical instrument to collect said vocal/musical signal therefrom,

an output device which comprises an output terminal for connecting with an audio outputting device; and

an audio streaming transceiver, which comprises:

a signal transmitter communicating with said input device for broadcasting said vocal/musical signal, wherein said signal transmitter comprises a modulating circuit modulating said vocal/musical signal via 2.4 GHz or higher band as radio frequency to form an uncompressed modulated signal to keep the quality of said vocal/musical signal; and

a signal receiver communicating with said output device for receiving said vocal/musical signal, wherein said modulated signal is demodulated into a digital signal and converted said digital signal back to said vocal/musical signal in analog form for being output through said audio outputting device.

These and other objectives, features, and advantages of the present invention will become apparent from the following detailed description, the accompanying drawings, and the appended claims.

### BRIEF DESCRIPTION OF THE DRAWINGS

FIG. 1 illustrates a block diagram of the method of transmitting vocal/musical signals via 2.4 GHz or higher wireless communication.

FIG. 2 illustrates a flow diagram of the method of transmitting signals via wireless communication using buffer transmitting to avoid error.

FIG. 3 is a perspective view of a portable wireless system.

FIG. 4 is a perspective view of a bodypack wireless system.

FIG. 5 is a perspective view of a bodypack wireless system with duplex mode.

FIG. 6 is a perspective view of a wireless microphone.

### DETAILED DESCRIPTION OF THE PREFERRED EMBODIMENT

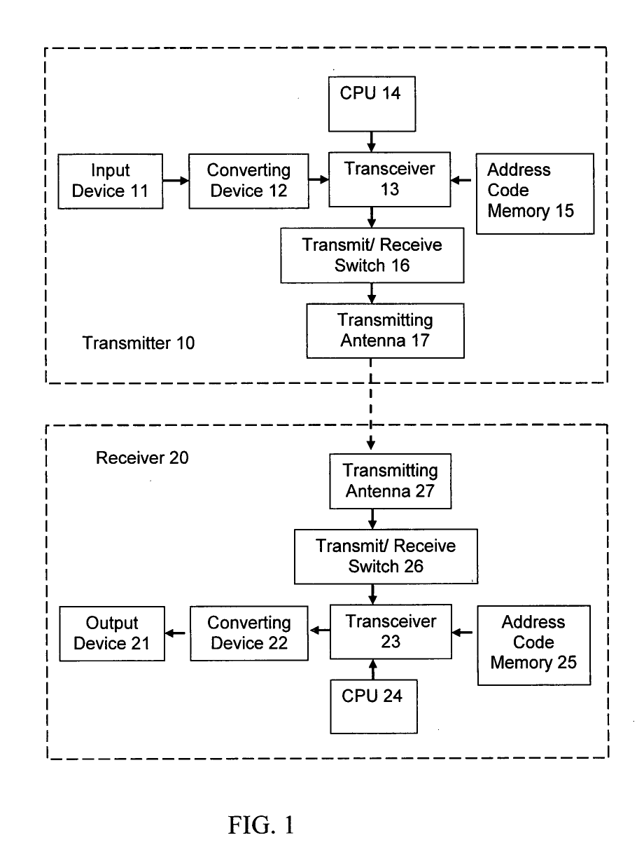

According to FIG. 1, a method of transmitting vocal/musical signals via 2.4 GHz or higher wireless communication is illustrated. Referring to FIG. 1, vocal/musical signals are first collected by an input device 11 of a transmitter 10. This input device 11 preferably collects signals from a microphone, or alternatively from a musical instrument such as a guitar, a keyboard, or a like. If the input signal is analog signal, it needs to be converted to digital signal. The collected signals are processed by a converting device 12. To guarantee the sound quality, a relatively high sampling rate, preferably over 24 bit 96 kspl/s (kilo sample per second) is needed. These digital signals are sent to an audio streaming transceiver 13 without being compressed. Digital signals without being compressed carry all the information which can recover the sound of full frequency band which can be felt by human hearing, normally known as 20 to 20,000 Hz. This enables high fidelity sound transitions. Also because there is no need for compression and decompression, the manufactory cost is largely saved.

This transceiver 13 is controlled by a CPU 14, and is electrically connected with an address code memory 15. With the CPU 14 and the address code memory 15, the transceiver is programmed to change the radio frequency actively. One preferred method is dynamic frequency hopping. The 2.4 GHz or higher band is divided into multiple predetermined channels. Each channel has a bandwidth larger than the bandwidth of the signals, and is not overlapped with others. The transceiver changes the channel periodically, with a predetermined time threshold, preferably for example, every 3 ms. So even if an interference happens, it will not affect more than 3 ms and will not be realized by human hearing. Another alternative method is changing the channel manually. The user sends command to the CPU 14, the CPU 14 then controls the transceiver 13 to change the channel. Another alternative method is, when error is detected, the CPU 14 then controls the transceiver 13 to change the channel.

After the modulation, the final radio signals are then fed to the transmitting antenna 17 through a high speed transmit/receive switch 16, and emitted into the air. In one embodiment, a preferable chipset to perform the modulation and transmission is Nordic Semiconductor's nRF24Z1® transceiver.

Referring to FIG. 1, the radio signals transmitted by the transmitter 10 are received by the receiving antenna 27 of the receiver 20, and sent to the audio streaming transceiver 23 through a high speed transmit/receive switch 26. The transceiver 23 demodulates the radio signals back to the digital signals. Since the transmitted signals are not compressed, no decompressing is needed. This saves the manufactory cost. These digital signals are then converted to analog signals by a converting device 22, and sent to the output device 21. The audio frequency response of the output covers the full frequency band which can be felt by human hearing, normally know as 20 to 20,000 Hz which can guarantee the high fidelity of transmitting.

In one preferred embodiment, this method also works in duplex way. The audio streaming transceiver can do both transmitting and receiving, and work with input and output instruments together at the same time. Applying this method to wireless microphone and headset, for example, a singer can hear the sound of his/her voice and the music sent back from the mixer when he/she is singing. It is quite helpful for performance on stage.

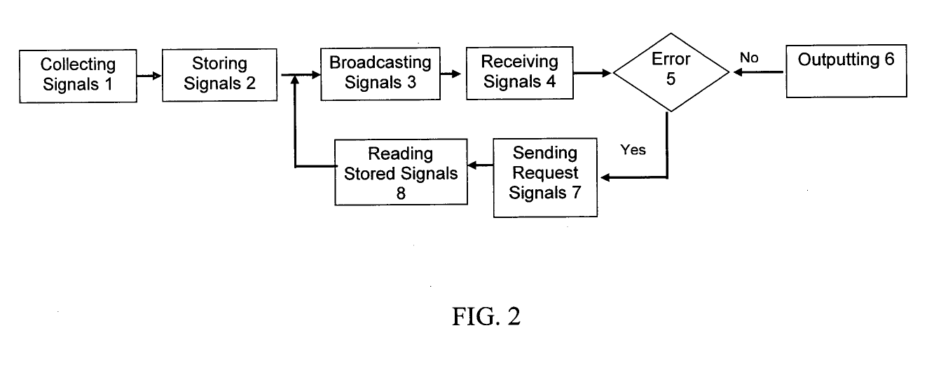

According to FIG. 2, a method of transmitting wireless signals via wireless communication with buffer transmitting is illustrated. In block 1, wireless signals are first collected. In block 2, said collected signals are stored. The storing device continuously stores new signals and keeps a predetermined period time of signals. This provides a buffer of the updated period time of signals constantly. In block 3 said stored signals are broadcasted. In block 4 said broadcasted signals are received. In block 5, if there is no error detected, in block 6 said received signals will be outputted with a short time delay. The time of the delay is no longer than the time of said signals which are stored in said storing device, and is no longer than human hearing can feel. If any error is detected, for example failed receiving due to interference, in block 7 a request will be sent to request broadcasting the signals again. Then in block 8 the signals will be read from the storing device, and will be broadcasted again. The re-broadcasted signals will be outputted without delay or with a shorter time of delay to keep the output constancy.

In one preferred embodiment, the signals are audio signals. In another preferred embodiment, the preferable time of delay is 12 ms, so human hearing can not tell the delay.

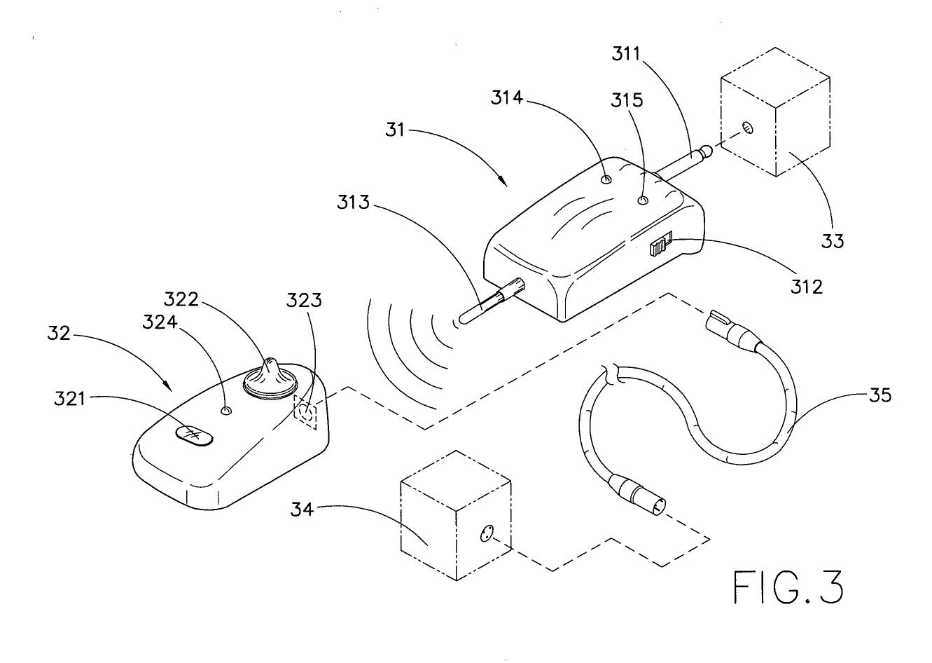

FIG. 3 is a perspective view of a portable wireless system. The system comprises two components, the transmitter 31 and the receiver 32. The transmitter 31 comprises a connector 311 which can be electrically connected with musical instruments 33 to collect input signals. In one preferred embodiment, the musical instrument is preferably a guitar or a like, the connector 311 is a jack plug. A switch 312 is operatively mounted on the transmitter 31 to control the power of the transmitter 31. The antenna 313 is used for emitting radio signals. The input signals are converted into digital signals and modulated into radio signals with the method of transmitting vocal and audio signals via 2.4 GHz or higher wireless communication. The LED light 314 is used to illustrate the power status. The LED light 315 is used to illustrate transmitting status.

The receiver comprises a switch 321 to control the power. The antenna 322 receives the radio signals from the air. These signals are then demodulated with the method of transmitting vocal and audio signals via 2.4 GHz or higher wireless communication. A connector 323 is mounted on the receiver. In one preferred embodiment the connector is a XLR jack. The demodulated signals can be transferred to an output device 34 such as an amplifier. In one preferred embodiment signals are transferred from connector 323, through an XLR cable 35, to the output device 34. The LED light 324 is used to illustrate the power status.

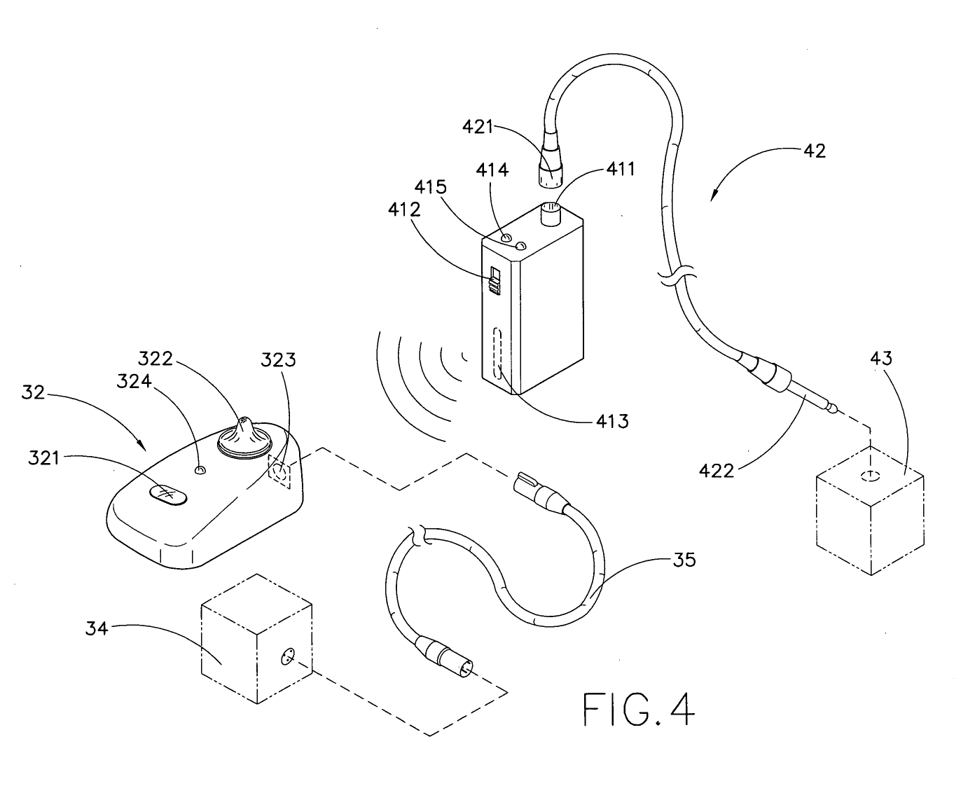

FIG. 4 is a perspective view of a bodypack wireless system. The system comprises two components, the bodypack 41 and the receiver 32. In one preferred embodiment, the bodypack 41 can be electrically connected with the input device by a connector 411 and a cable 42. At one end of the cable is a connector 421 which can be electrically connected with connector 411, at the other end of the cable is a connector 422 which can be electrically connected to the input device 43. In one preferred embodiment, the input device 43 is a guitar or a microphone, or a like. A switch 412 controls the power of the transmitter. The antenna 413 is embedded inside the bodypack transmitter and is used for emitting radio signals. The input signals are converted into digital signals and modulated into radio signals with the method of transmitting vocal and audio signals via 2.4 GHz or higher wireless communication. The LED light 414 is used to illustrate the power status. The LED light 415 is used to illustrate transmitting status.

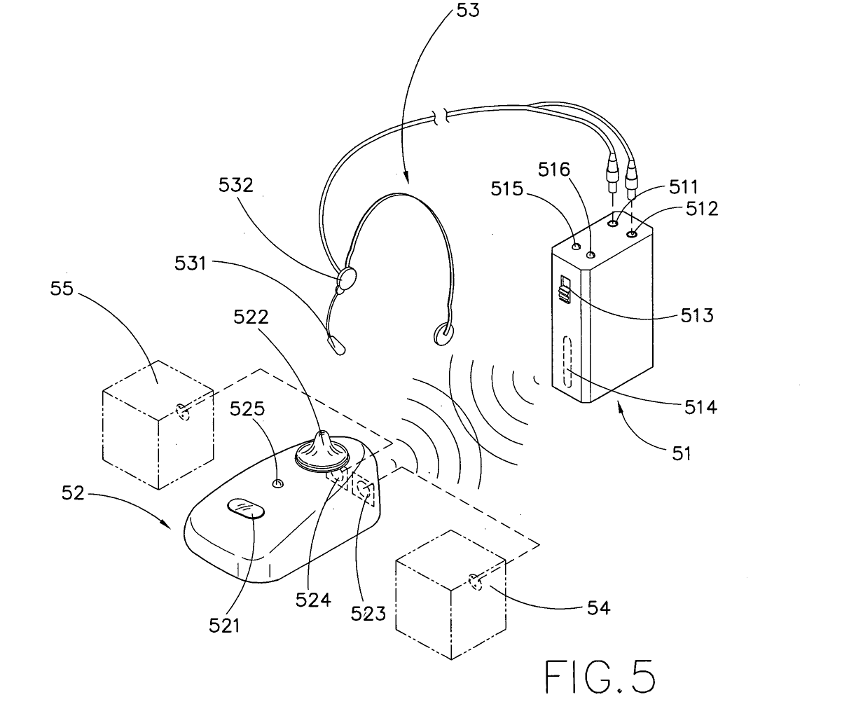

FIG. 5 is a perspective view of a bodypack wireless system with duplex mode. The system comprises two components, a bodypack 51 and a base 52. Both two components transmit and receive radio signals with the method of transmitting vocal and audio signals via 2.4 GHz or higher wireless communication.

The bodypack 51 comprises two connectors, 511 and 512. In one preferred embodiment, the connector 511 can be electrically connected with a microphone 531 of a microphone-headset set 53. The transceiver transmits the vocal signals collected from the microphone 531, at the same time, receives signals and outputs to the headset 532 of the microphone-headset set 53. A switch 513 controls the power of the transmitter. The antenna 514 is embedded inside the bodypack and is used for transmitting/receiving radio signals. The LED light 515 is used to illustrate the power status. The LED light 516 is used to illustrate transmitting status.

The base 52 comprises a switch 521 to control the power. The antenna 522 transmits/receives the radio signals. The base 52 comprises a connector 523 for output which can output signals to an output device 54. The base 52 also comprises another connector 524. This connector 524 can receive input signals from an input device 55. In one preferred embodiment, the input device 55 is a mixer or a like. In this situation, a user's voice can be collected by the microphone 531 and be transmitted to the output device 54 through the wireless system, as the same time, the user can also hear the sound of the output device 55, for example, the final sound mixed with the user's voice and the background music. With this system, a singer can always hear the same result as the audients can hear, and easily control his voice. The LED light 525 is used to illustrate the power status.

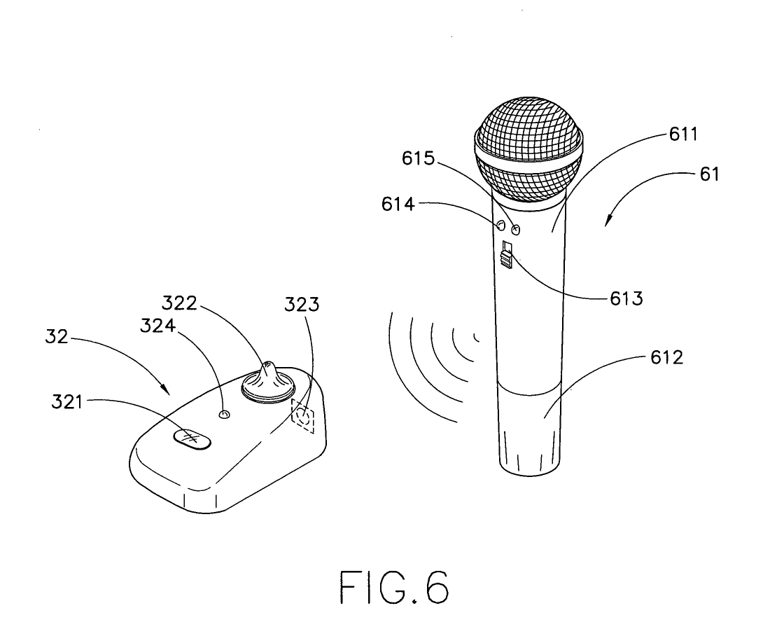

FIG. 6 is a perspective view of a wireless microphone. The wireless microphone comprises a handhold system 61 and a base 32. The handhold system 61 comprises a microphone 611 and a transmitter 612, which are electrically connected with each other. The vocal/musical signals collected by the microphone 611 are inputted into the transmitter 612. These signals are then broadcasted by the transmitter 612 and received by the base 32 with the method of transmitting vocal/musical signals via 2.4 GHz or higher wireless communication. A switch 613 controls the power of the handhold system 61. The LED light 614 is used to illustrate the power status. The LED light 615 is used to illustrate transmitting status.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of transmitting vocal/musical signal via 2.4 GHz or higher wireless communication between a microphone/musical instrument and an audio outputting device, comprising the steps of:
(a) collecting a vocal/musical signal from said microphone/musical instrument via an input device;
(b) modulating said vocal/musical signal via 2.4 GHz or higher band as radio frequency to form an uncompressed modulated signal to keep the quality of said vocal/musical signal;
(c) wirelessly transmitting said modulated signal through an audio streaming transceiver;
(d) demodulating said modulated signal into a digital signal; and
(e) converting said digital signal back to said vocal/musical signal in analog form to be outputted through said audio outputting device.

2. The method, as recited in claim 1 wherein the step (c) further comprises the steps of:
(c.1) broadcasting said modulated signal via a signal transmitter of said audio streaming transceiver in an uncompressed signal transmitting manner, wherein said signal transmitter is communicatively connected to said input device; and
(c.2) wirelessly receiving said modulated signal via a signal receiver of said audio streaming transceiver, wherein said signal receiver is communicatively connected to said audio outputting device.

3. The method, as recited in claim 2, wherein the step (c.2) further comprises the steps of:
(c.2.1) communicating said signal receiver with said signal transmitter through a plurality of RF channels to transmit said modulated signal; and
(c.2.2) automatically switching from one of said RF channels to another said RF channel to optimize said modulated signal being transmitted so as to keep the quality of said vocal/musical signal through said audio streaming transceiver.

4. The method, as recited in claim 3, wherein said RF channels are arrayed in an order manner such that said RF channels are automatically switched in a sequent order.

5. The method, as recited in claim 3, wherein said RF channels are automatically switched at a predetermined time threshold to minimize the loss of said modulated signal during wireless transmission.

6. The method, as recited in claim 4, wherein said RF channels are automatically switched at a predetermined time threshold to minimize the loss of said modulated signal during wireless transmission.

7. The method, as recited in claim 1, wherein said audio streaming transceiver is a duplex wireless communication device for said vocal/musical signal being transmitted back and forth between said microphone/musical instrument and said audio outputting device.

8. The method, as recited in claim 6, wherein said audio streaming transceiver is a duplex wireless communication device for said vocal/musical signal being transmitted back and forth between said microphone/musical instrument and said audio outputting device.

9. A method of transmitting wireless signal via wireless communication system, comprising the steps of:
(a) collecting said wireless signal;
(b) wirelessly broadcasting said wireless signal via a wireless transmitter of said wireless communication system;
(c) receiving said wireless signal from a signal receiver of said wireless communication system;
(d) sending a requesting signal from said signal receiver to said signal transmitter when an error of said wireless signal is detected during wireless transmission; and
(e) re-broadcasting said wireless signal as a makeup signal via said wireless transmitter to replace said error of said wireless signal.

10. The method, as recited in claim 9, wherein the step (a) further comprises the steps of:
(a.1) directing said wireless signal to form an out-going signal to be wirelessly broadcasted; and
(a.2) buffering said wireless signal to form a stored signal to be re-broadcasted when said requesting signal is sent by said signal receiver.

11. The method, as recited in claim 10, further comprising the steps of:
(f) sending said wireless signal to an outputting device in a time-delay manner to form a time zone for said makeup signal to replace said error of said wireless signal;
(g) outputting said wireless signal via said outputting device.

12. The method, as recited in claim 9, wherein said wireless signal is a vocal/musical signal to be transmitted from a microphone/musical instrument.

13. The method, as recited in claim 11, wherein said wireless signal is a vocal/musical signal to be transmitted from a microphone/musical instrument.

14. The method, as recited in claim 13, wherein said out-going signal is an uncompressed signal and said stored signal is a compressed signal.

15. The method, as recited in claim 13, wherein the step (c) further comprises the steps of:
(c.1) communicating said signal receiver with said signal transmitter through a plurality of RF channels to transmit said wireless signal; and
(c.2) automatically switching from one of said RF channels to another said RF channel to optimize said wireless signal being transmitted so as to keep the quality of said wireless signal through said wireless communication system.

16. A wireless communication system for transmitting vocal/musical signal via 2.4 GHz or higher wireless communication, comprising:
an input device which comprises an input terminal for connecting with a microphone/musical instrument to collect said vocal/musical signal therefrom,
an output device which comprises an output terminal for connecting with an audio outputting device; and
an audio streaming transceiver, which comprises:
a signal transmitter communicating with said input device for broadcasting said vocal/musical signal, wherein said signal transmitter comprises a modulating circuit modulating said vocal/musical signal via 2.4 GHz or higher band as radio frequency to form an uncompressed modulated signal to keep the quality of said vocal/musical signal; and
a signal receiver communicating with said output device for receiving said vocal/musical signal, wherein said modulated signal is demodulated into a digital signal and converted said digital signal back to said vocal/musical signal in analog form for being output through said audio outputting device.

17. The wireless communication system, as recited in claim 16, wherein said audio streaming transceiver further comprises a RF channel controller automatically switching from one RF channel to another RF channel to optimize said modulated signal being transmitted so as to keep the quality of said vocal/musical signal through said audio streaming transceiver.

18. The wireless communication system, as recited in claim 17, wherein said RF channel controller arrays said RF channels in an order manner that said, RF channel controller controllably switches said RF channels in a sequent order and at a predetermined time threshold to minimize the loss of said modulated signal during wireless transmission.

19. The wireless communication system, as recited in claim 16, wherein said audio streaming transceiver is a duplex wireless communication device for said vocal/musical signal being transmitted back and forth between said microphone/musical instrument and said audio outputting device.

20. The wireless communication system, as recited in claim 18, wherein said audio streaming transceiver is a duplex wireless communication device for said vocal/musical signal being transmitted back and forth between said microphone/musical instrument and said audio outputting device.
